(19) United States
(12) Patent Application Publication
(10) Pub. No.: US 2022/0224370 A1
(43) Pub. Date: Jul. 14, 2022

(54) CASE STRUCTURE FOR MOBILE PHONE, TABLET, AND SIMILAR ELECTRONIC DEVICES

(71) Applicant: Edip Ali ELITAS, Ankara (TR)

(72) Inventor: Edip Ali ELITAS, Ankara (TR)

(21) Appl. No.: 17/613,976

(22) PCT Filed: Nov. 5, 2020
(86) PCT No.: PCT/TR2020/051046

§ 371 Date: Nov. 24, 2021

(30) Foreign Application Priority Data
Oct. 21, 2020 (TR) 2020/16833

(51) Int. Cl. H04B 1/3888

(52) U.S. Cl. CPC H04B 1/3888

(57) ABSTRACT

A device case with an inner surface and an outer surface, with inner edge surfaces and outer corner surfaces, wherein the device case provides a protection for electronic devices such as mobile phones, tablets, laptops, and a like against external factors, wherein the device case includes impact absorbers with a plurality of tiny balls formed on the inner surface and/or the outer surface.

### CROSS REFERENCE TO THE RELATED APPLICATIONS

This application is the national stage entry of International Application No. PCT/TR2020/051046, filed on Nov. 5, 2020, which is based upon and claims priority to Turkish Patent Application No. 2020/16833, filed on Oct. 21, 2020, the entire contents of which are incorporated herein by reference.

### TECHNICAL FIELD

The invention relates to a case structure that provides protection of electronic devices such as mobile phones, tablets, laptops and the like against external factors.

The present invention relates to impact-absorbing particles, which are formed on the outer protective cover and mostly on its inner surface, have a shock—absorbing feature, preferably containing a spherical structure.

### BACKGROUND

As is known, the cases are protective materials used in the protection of electronic devices such as mobile phones, tablets, laptops, and the like against external factors. They have various visual designs according to their areas of use or their features, as well as different material and technical properties.

For example, in terms of material, polymer cases are produced from a single material (hard or soft), or by double injection method from elastomer inside and hard polymer material outside. The outer hard surface is protected against scratches, and the inner soft surface is used to absorb and disperse impact. In order for the case to stretch as the device is inserted into it, the elastomer channels are formed at the corners.

Another problem experienced in the current technique is that the laminated elastomer and hard polymer, which are adhered to each other, show different expansion properties in hot climates and with humidity. Elastomer parts (in places such as button edges, socket edges) become loose, therefore it looks both aesthetically bad and undergoes deformations that will affect the function such as rupture or tearing.

In the patent research conducted on the Prior Art, a patent with number CN105452128B has been found. In this patent application, multiple shock—absorbing surfaces have been created on the inner surface of the case and in the designated areas.

Another application is US Patent no. US20150001104. This patent application also includes impact absorbing surfaces formed on the inner surface of the case similar to the said above Chinese patent. The surfaces used here are impact-absorbing surfaces that extend along the inner surface of the phone.

The case presented in the patent application numbered USD606305S1 contains impact absorbing protrusions formed on both the outer and inner surfaces. The impact-absorbing protrusions revealed in this application have a long structure and protects the phone against external factors.

### SUMMARY

The invention is intended to produce a case with different technical features which, unlike the case structures used in the present market, that bring new development to this area.

The most important purpose of the invention is to protect the phone and similar electronic devices from the effects of damaging physical actions such as dropping or crashing.

Another purpose of the invention is to create a surface by combining elastomer, ie soft polymer materials in the form of tiny balls, to the surfaces that will contact the phone or device on the inner surface of the case. Thus, each of these balls has a separate damping feature to increase the ability to absorb impact.

The other purpose of the invention is to obtain the surface by combining elastomer i.e. soft polymer materials in tiny balls on the outer surfaces of the case, not just the inner surface of it, and to absorb the impacts with the individual damping feature of each of these balls.

Another purpose of the invention is to create elastomer channels near corners on long edges to make it easier for the phone or device to be placed in the case. Thus, thanks to the channels created in the area where the resistance is low, the device is placed in the case more easily with less force. In order to fulfill the purposes described above, the invention is a device case with an inner surface and an outer surface, with inner edge surfaces and outer corner surfaces, which provides protection for electronic devices such as mobile phones, tablets, laptops, and the like against external factors, wherein;
the said device case comprising of impact absorbing particles or layers with tiny spherical balls formed on the inner surface and/or outer surface of the case.

### BRIEF DESCRIPTION OF THE DRAWINGS

FIG. 1 is the two-dimensional view of the three views of the case of the invention.

FIG. 2 is a general view of the case of the invention as impact absorbing materials are placed on the inner surface.

FIG. 3 is a general view of the case of the invention as impact-absorbing materials are placed on the inner edge surfaces.

FIG. 4 is a general view of the case of the invention as impact-absorbing materials are placed on the inner corner edge surface.

FIG. 5 is a general view of the case of the invention as impact-absorbing materials are placed on the outer corner edge surfaces.

FIG. 6 is the plate form of the impact-absorbing material and the disassembled view of the shape to be adapted to the inner surface.

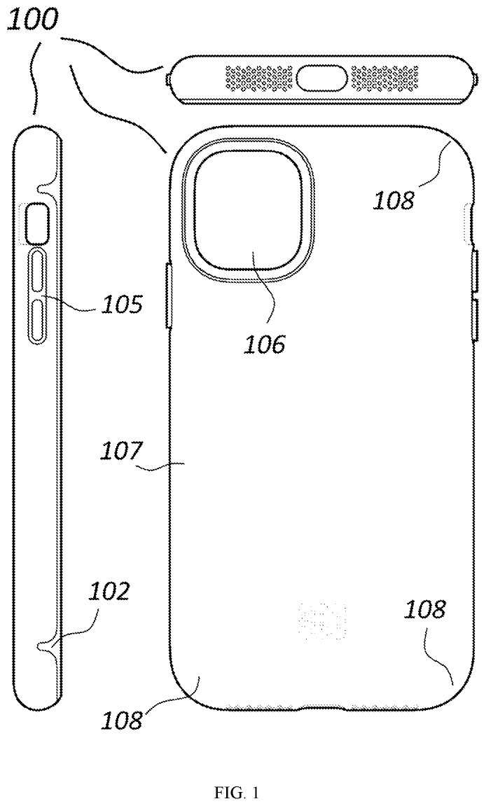

### REFERENCE NUMBERS

100 Device case
101 Inner surface
102 Stretching hole
103 Inner edge surfaces
104 Inner corner surfaces
105 Modular buttons
106 Camera hole
107 Outer surface
108 Outer corner surfaces
109 Long edge
110 Short edge
200 Impact absorber
201 Tiny balls
202 Plate form

### DETAILED DESCRIPTION OF THE EMBODIMENTS

With the invention, a device case (100) that provides protection of electronic devices such as mobile phones, tablets, laptops, and the like against external factors is explained. The device case (100) comprises an impact absorber (200) built on the inner surface (101) and/or outer surface (107). This impact absorber (200) material is formed of a multiple number of tiny balls (201), and these tiny balls (201) have a flexible, preferably spherical structure.

The said impact absorber (200) are tiny balls (201) that are adapted by laying or by spreading method on the inner surface (101) and/or the outer surface (107) of the device case (100) during the production phase. It is possible that these tiny balls (201) can be adapted to the surface (101) or outer surface (107) of the device case (100) by pouring or laying on the surface during the production phase, and it is also possible to form a layer adjacent and close to the tiny balls (201) and to adapt this layer to the case by cutting it to the desired dimensions. In this way, a plate form (202) is obtained that allows the impact absorber (200) to be adapted as a whole layer on the inner surface (101) and/or the outer surface (107) of the device case (100).

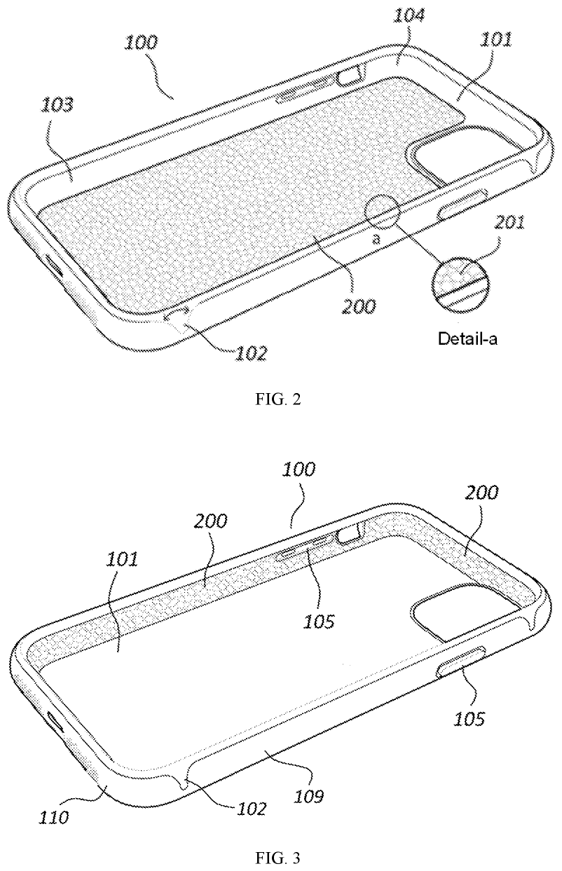

In FIG. 2, the impact absorber (200) of the invention is adapted to the inner surface (101) of the device case (100). The tiny balls (201), which are fully spread on the inner surface (101) and adapted to this area, are composed of small flexible balls of spherical structure as stated in detail a. It shows a superior suspense effect between the case and the device, highly preventing damage to the device from impact. At the same time, it has a feature that is highly appealing and can be the center of attention of the consumer visually. The tiny balls (201) can be of different colors as desired. Thus, it is possible to obtain country flag colors, sports team colors and combinations of different colors.

In FIG. 3, the view of the inner surface (101) of the shock absorber (200) device case (100) adapted to the inner edge surfaces (103) is illustrated. The stretching hole (102) is formed on the long edge (109) of the device case (100) but also close to the short edge (110). The stretching hole (102) stretches while the phone or device is placed in the case, so that the device is placed into the case easily and effortlessly. Also, modular buttons (105) are created on the long edges of the case (109). Modular buttons (105) are available in different colors according to the preference.

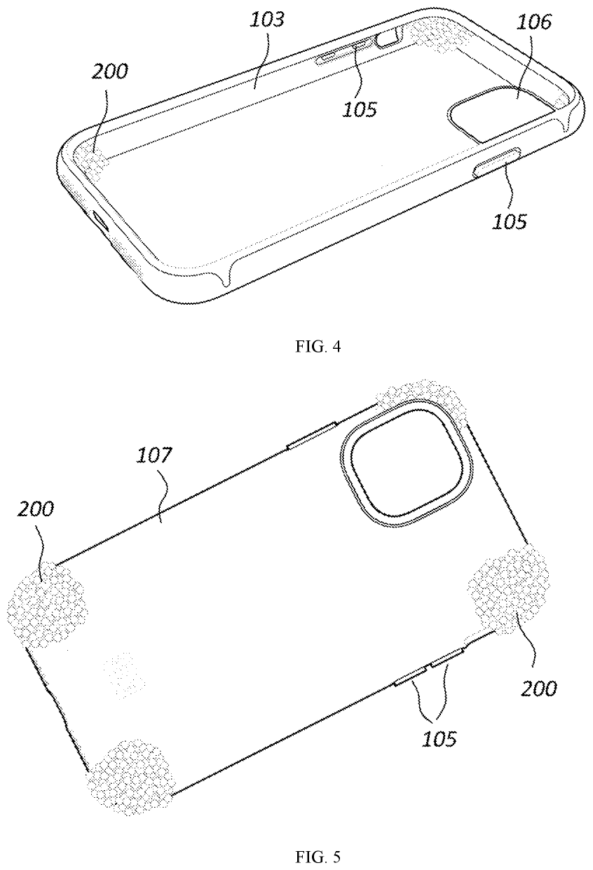

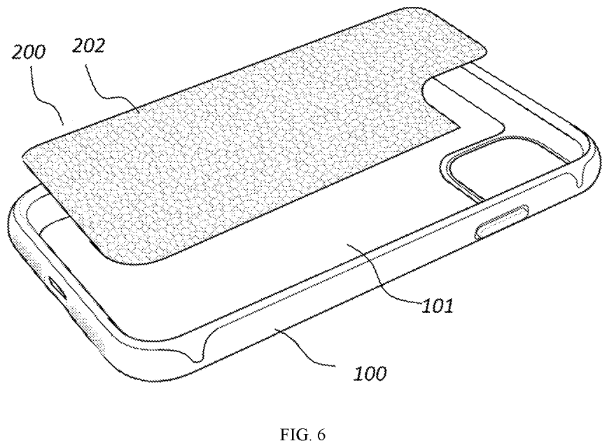

In FIGS. 4 and 5, the appearance of the shock absorber (200) device case (100) adapted to the inner corner surfaces (104) and outer corner surfaces (108) is illustrated. The impact absorber (200) can generally be fixed to the inner and outer surfaces of the device case (100) by bonding or thermal technique or using different techniques.

In FIG. 6, the impact absorber (200) tiny balls (201) is layered and then the appearance of adapting to the inner surface of the case is illustrated. The shock absorber (200) in the form of a layer is fixed to the inner surface of the case by bonding technique after it is cut in rolls and then in accordance with the inner surface of the case.

On the other hand, the outer surface (107) and/or outer corner surfaces (108) of the device case (100) contain transparent surfaces. Because these surfaces are transparent surfaces, the tiny balls (201) remaining inside will be visible from outside and a product with a high charm and design will be obtained. Also, the said impact absorber (200) tiny balls (201) may comprise the company logo, football and/or different sports team emblems, and plate form (202) layer with different visuals and shapes. Thus, it is also possible for people to individually provide this shaped plate form (202) layer which is produced in various ways according to their preferences and to adhere to their cases by themselves.

What is claimed is:

1. A device case with an inner surface and an outer surface, with inner edge surfaces and outer corner surfaces, wherein the device case provides a protection for electronic devices against external factors, and the electronic devices comprise mobile phones, tablets, and laptops,
the device case comprises impact absorbers with a plurality of tiny balls formed on the inner surface and/or the outer surface,
wherein the impact absorbers with the plurality of tiny balls are adapted by a laying method or by a spreading method on the inner surface and/or the outer surface of the device case during a production phase,
the device case further comprising a plate form allowing the impact absorbers to be adapted as a whole layer on the inner surface and/or the outer surface of the device case.

2. The device case according to claim 1, wherein each of the plurality of tiny balls comprises a spherical structure with a flexible structure.

3. (canceled)

4. (canceled)

5. The device case according to claim 1, comprising a stretching hole formed on a long edge of the device case near a short edge.

6. The device case according to claim 1, wherein the outer surface and/or outer corner surfaces of the device case comprises transparent surfaces for the plurality of tiny balls to be seen.

7. The device case according to claim 1, wherein the impact absorbers with the plurality of tiny balls comprise a plate form layer containing logos, emblems, and different images and shapes.
